(19) United States
(12) Patent Application Publication
(10) Pub. No.: US 2012/0169496 A1
(43) Pub. Date: Jul. 5, 2012

(54) PORTABLE ELECTRONIC DEVICE WITH ANTI-THEFT FUNCTION AND ANTI-THEFT METHOD

(75) Inventors: QIANG YOU, Shenzhen City (CN); HAI-WEN WANG, Shenzhen City (CN); XIAN-ZENG HUANG, Shenzhen City (CN); CHENG-ZHI LI, Shenzhen City (CN); CHONG-JIN MA, Shenzhen City (CN); YANG XIN, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/172,842

(22) Filed: Jun. 30, 2011

(30) Foreign Application Priority Data
Dec. 31, 2010 (CN) 201010616809.9

(51) Int. Cl. G08B 21/00

(52) U.S. Cl. 340/540

(57) ABSTRACT

A portable electronic device includes a plurality of touch sensing units for covering a surface of the portable electronic device. Each touch sensing unit is capable of generating touch sensing signals when the touch sensing units are touched. The portable electronic device stores at least one predetermined figure. The portable electronic device determines positions of the touched touch sensing units on the surface of the portable electronic device when the touch sensing unit is touched, and generates a touch figure according to the determined position of each touched touch sensing unit on the surface of the portable electronic device. The portable electronic device computes a similarity degree between the generated touch figure and the predetermined figure, and generates an alarm instruction to control an alarm unit to output an alarm signal if the computed similarity degree is greater than the predetermined value.

### BACKGROUND

1. Technical Field

The present disclosure relates to a portable electronic device with an anti-theft function and an anti-theft method.

2. Description of Related Art

As portable electronic devices become smaller and lighter, it becomes easier to steal them from a bag or pocket of user if the user is careless or has their attention diverted.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of a portable electronic device with an anti-theft function in accordance with an exemplary embodiment.

FIG. 2 is a flow chart of an anti-theft method applied on the electronic device of FIG. 1 in accordance with an exemplary embodiment.

### DETAILED DESCRIPTION

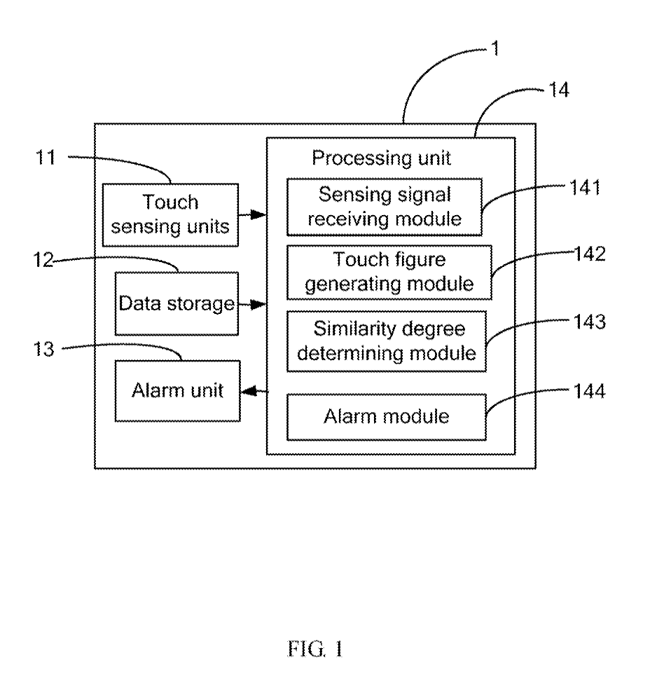

FIG. 1 is a block diagram of a portable electronic device with an anti-theft function in accordance with an exemplary embodiment. The portable electronic device 1 includes a number of touch sensing units 11, a data storage 12, an alarm unit 13, and a processing unit 14. The touch sensing units 11 cover the surface of the portable electronic device 1. Each touch sensing unit 11 is capable of generating touch sensing signals when the touch sensing units 11 are touched and transmitting the touch sensing signals to the processing unit 14 for processing. The data storage 12 stores at least one predetermined figure. When a thief steals the portable electronic device 1, the thief may use two fingers, such as a forefinger and a middle finger, to grip the portable electronic device 1 from a bag or pocket of user. The predetermined figure stored in the data storage 12 is a simulation figure that simulates a gesture of the fingers touching the portable electronic device 1 when the portable electronic device 1 is gripped by the fingers. In the present embodiment, the simulation gesture is two direct lines, each of them is a figure that the user touches the surface of the portable electronic device 1. The alarm unit 13 outputs an alarm signal in response to the instruction of the processing unit 14. In the present embodiment, the alarm unit 13 is a speaker, and the alarm signal is a predetermined audio file stored in the data storage 12.

The processing unit 14 includes a sensing signal receiving module 141, a touch figure generating module 142, a similarity degree determining module 143, and a alarm module 144. The sensing signal receiving module 141 is for receiving the touch sensing signals transmitted from touched touch sensing units 11. The touch figure generating module 142 determines positions of the touched touch sensing units 11 on the surface of the portable electronic device 1 according to the received touch sensing signals, and generates a touch figure according to the determined position of touch sensing units 11 on the surface of the portable electronic device 1. In the present embodiment, the touch figure generating module 142 generates the touch figure by connecting the determined position of each touch sensing unit 11 on the surface of the portable electronic device 1. The similarity degree determining module 143 computes a similarity degree between the generated touch figure and the predetermined figure stored in the data storage 12, and determines whether the computed similarity degree is greater than a predetermined value. In the present embodiment, if the touch figure is two resemble direct lines, the similarity degree determining module 143 determines whether the similarity degree between the generated touch figure and the predetermined figure is greater than a predetermined value. When the computed similarity degree is greater than the predetermined value, the alarm module 144 generates an alarm instruction to control the alarm unit to output the alarm signal.

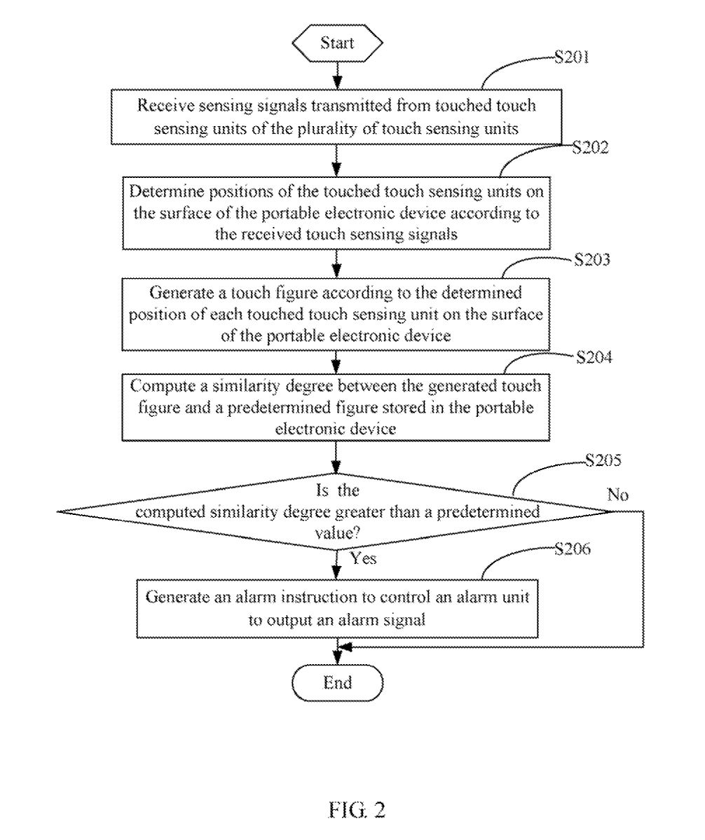

FIG. 2 is a flow chart of an anti-theft method applied on the electronic device of FIG. 1. In step S201, the sensing signal receiving module 141 receives the touch sensing signals transmitted from the touch sensing units 11.

In step S202, the touch figure generating module 142 determines positions of the touch sensing units 11 that generate the touch sensing signals on the surface of the portable electronic device 1.

In step S203, the touch figure generating module 142 generates the touch figure according to the determined position of touch sensing units 11 on the surface of the portable electronic device 1.

In step S204, the similarity degree determining module 143 computes the similarity degree between the generated touch figure and the predetermined figure stored in the data storage 12.

In step S205, the similarity degree determining module 143 determines whether the computed similarity degree is greater than a predetermined value, if the computed similarity degree is not greater than a predetermined value, the procedure goes to end.

If the computed similarity degree is greater than the predetermined value, in step S206, the alarm module 144 generates an alarm instruction to control the alarm unit 13 output the alarm signal.

Although, the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. A portable electronic device with an anti-theft function, comprising:
a plurality of touch sensing units covering a surface of the portable electronic device, wherein each touch sensing unit is capable of generating touch sensing signals when the touch sensing unit is touched;
a data storage for storing at least one predetermined figure;
an alarm unit for outputting an alarm signal; and
a processing unit comprising:
a sensing signal receiving module for receiving the touch sensing signals transmitted from touched touch sensing units of the plurality of touch sensing units,
a touch figure generating module for determining positions of the touched touch sensing units on the surface of the portable electronic device according to the received touch sensing signals, and generating a touch figure according to the determined position of each touched touch sensing unit on the surface of the portable electronic device;
a similarity degree determining module for computing a similarity degree between the generated touch figure and the predetermined figure stored in the data storage, and determining whether the computed similarity degree is greater than a predetermined value; and
an alarm module for generating an alarm instruction to control the alarm unit to output the alarm signal if the computed similarity degree is greater than the predetermined value.

2. The electronic device as described in claim 1, wherein the predetermined figure is a simulation figure that simulates a gesture of the fingers touching the portable electronic device when the portable electronic device is gripped by the fingers.

3. The electronic device as described in claim 2, wherein the simulation gesture is two direct lines, each of them is a figure that the user touches the surface of the portable electronic device, if the touch figure is two resemble direct lines, the similarity degree determining module determines the similarity degree between the generated touch figure and the predetermined figure is greater than a predetermined value.

4. The electronic device as described in claim 2, wherein the gesture of the fingers is a gesture of a forefinger and a middle finger.

5. The electronic device as described in claim 1, wherein the alarm unit is a speaker.

6. The electronic device as described in claim 1, wherein the alarm signal is a predetermined audio stored in the data storage.

7. The electronic device as described in claim 1, wherein the touch figure generating module generates the touch figure by connecting the determined position of each touched touch sensing unit on the surface of the portable electronic device.

8. An anti-theft method applied on a portable electronic device, a surface of the portable electronic device being cover by a plurality of touch sensing units which is capable of generating touch sensing signals when touched, wherein the method comprises:
receiving sensing signals transmitted from touched touch sensing units of the plurality of touch sensing units;
determining positions of the touched touch sensing units on the surface of the portable electronic device according to the received touch sensing signals;
generating a touch figure according to the determined position of each touched touch sensing unit on the surface of the portable electronic device;
computing a similarity degree between the generated touch figure and a predetermined figure stored in the portable electronic device,
determining whether the computed similarity degree is greater than a predetermined value; and
generating an alarm instruction to control an alarm unit output an alarm signal if the computed similarity degree is greater than the predetermined value.

9. The method as described in claim 8, wherein the predetermined figure is a simulation figure that simulates a gesture of the fingers touching the portable electronic device when the portable electronic device is gripped by the fingers.

10. The method as described in claim 9, wherein the gesture of the fingers is a gesture of a forefinger and a middle finger.

11. The method as described in claim 8, wherein the alarm unit is a speaker.

12. The method as described in claim 8, wherein the alarm signal is a predetermined audio stored in the portable electronic device.

13. The method as described in claim 8, wherein the touch figure is generated by connecting the determined position of each touched touch sensing unit on the surface of the portable electronic device.
